(19) United States
(12) Patent Application Publication
(10) Pub. No.: US 2018/0375324 A1
(43) Pub. Date: Dec. 27, 2018

(54) Safety Protection for Class 2 Electrical Circuits

(71) Applicant: Nextek Power Systems, Inc., Detroit, MI (US)

(72) Inventors: Paul Wickett, Northville, MI (US); Jeff Hunsinger, Northville, MI (US)

(21) Appl. No.: 16/010,675

(22) Filed: Jun. 18, 2018

Related U.S. Application Data
(60) Provisional application No. 62/522,987, filed on Jun. 21, 2017.

(51) Int. Cl. H02H 9/00

(52) U.S. Cl. CPC H02H 9/00

(57) ABSTRACT

An electrical circuit is connected between a power source and a plurality of loads. A plurality of load protection devices is connected in parallel in a plurality of branches of a multi-branch, sub-circuit. Each one of the load protection devices is connected to each load in a respective branch. A single power protection device is connected in series between the power source and the sub-circuit. Each of the load protection devices in a respective branch and the single power protection device enable the circuit to have a Class 2 rating.

### FIELD OF THE DISCLOSURE

The present disclosure relates generally to Class 2 electrical circuits and, more particularly, to protecting such circuits with fewer protection devices than heretofore.

### BACKGROUND

The National Electrical Code (NEC) is a North American standard that describes the installation of electric conductors and equipment within or on buildings. The NEC is the source of the Class 2 electric circuit definition, which limits the maximum voltage and current in the electric circuit. Class 2 defines the portion of the wiring system between a power supply, e.g., typically rated at 24VDC and 100 W maximum, and one or more loads. Due to its power, voltage, and current limitations, the Class 2 circuit specifies, among other things, acceptable safety protection against electric shock.

The American National Standard Institute (ANSI) Underwriters Laboratories (UL) standards for electrical circuit safety include the UL-1310 Standard for Class 2 circuits. The UL-1310 Standard requires, among other things, that for a circuit to have a Class 2 rating, the circuit must be able to limit power, voltage, and current values despite a single electrical component failure in the circuit. To limit such electrical values, it is known to provide the circuit with various combinations of such protection devices as current sensors, voltage sensors, thermal cut-off protectors, switches, relays, comparators, microcontrollers, eFuses, and so on.

To meet the UL-1310 Standard for safety, it is known to provide a first protection device (PD) and a second redundant PD between a power source and each load. Thus, as shown in FIG. 1A, it is known to insert two PDs in a primary line to the load, and, as shown in FIG. 1B, it is also known to insert the first PD in a primary line, and the second PD in a secondary line, to the load. The PDs can be located on any combination of primary and secondary lines. Thus, it is conventional to provide two PDs for each load.

As advantageous as these known protection devices are, it would be desirable to reduce the cost and complexity of such Class 2 circuits, and to decrease the number of protection devices required, while still maintaining the Class 2 rating.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is an electrical schematic depicting one version of how protection devices may be installed in a Class 2 circuit, in accordance with the prior art.

FIG. 1B is an electrical schematic depicting another version of how protection devices may be installed in a Class 2 circuit, in accordance with the prior art.

FIG. 2 is an electrical schematic depicting how protection devices may be installed in a Class 2 circuit, in accordance with the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The circuit components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In accordance with one feature of this invention, an electrical circuit is connected between a power source and a plurality of loads. The circuit includes a plurality of load protection devices that are connected in parallel in individual branches of a sub-circuit. Each one of the load protection devices is connected to each load in an individual branch. A single power protection device is connected in series between the power source and the sub-circuit. Each one of the load protection devices in a respective branch and the single power protection device enable the circuit to have a Class 2 rating.

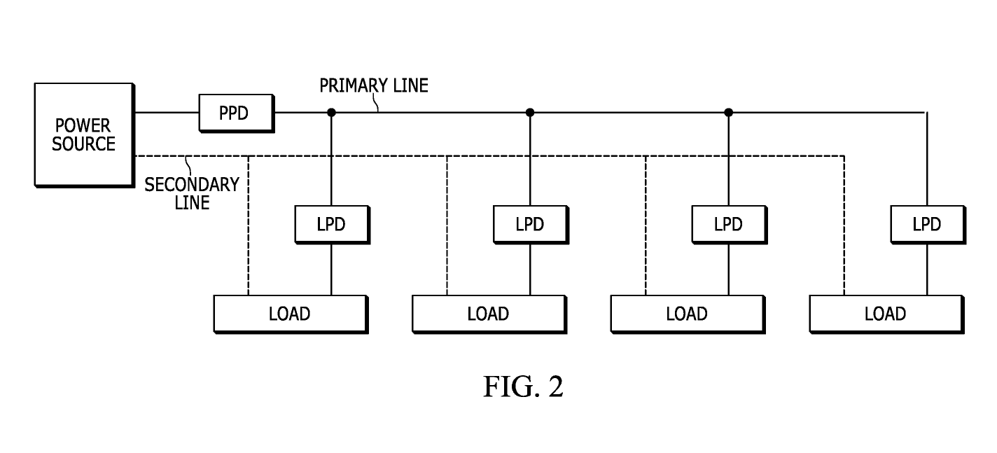

Turning now to FIG. 2 of the drawings, an electrical circuit is connected between a power source that supplies electrical power, and a plurality of loads that consume the electrical power. The power source is typically rated at 24VDC and 100 W maximum. Although four loads have been illustrated, any number of loads is envisioned by this disclosure. The loads are preferably DC loads, and in the illustrated case, each can handle 100 W/4=25 W. Each load is located in a branch of a multi-branch sub-circuit.

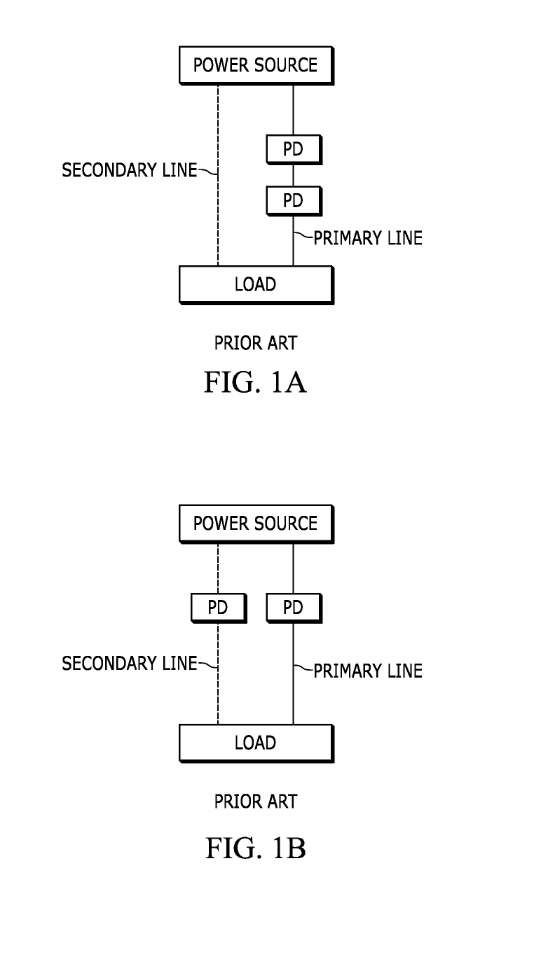

As described above in connection with FIGS. 1A, 1B, in order for the circuit to have a Class 2 rating, two protection devices need to be connected to each load in a respective branch of the multi-branch, sub-circuit. In other words, the number of PDs is equal to two times the number of Class 2 circuit branches and loads being protected. Thus, according to the prior art, eight (2 protection devices×4 loads) protection devices would be needed. This invention is directed to reducing this number of protection devices, for example, to the illustrated five protection devices, while still maintaining the Class 2 rating.

As shown in FIG. 2, the circuit includes a plurality of load protection devices (LPDs) that are connected in parallel in the individual branches of the multi-branch, sub-circuit. Each one of the load protection devices LPDs is connected to each load in an individual branch. A single power protection device (PPD) is connected in series between the power source and the sub-circuit. The circuit maintains its Class 2 rating, because each load is protected by the single PPD and the one LPD in each branch. The single PPD is shared by all of the loads and the branches. Thus, the number of protection devices is equal to one (i.e., the single PPD) plus the number of individual Class 2 branches and loads (as illustrated, four) being protected. The aggregate power consumed by all the loads is less than the maximum output power of the power source. Thus, if the power source is 100 W maximum, then the aggregate power consumed by all the loads is less than 100 W, per the UL-1310 Standard.

If the current, voltage, or power in the individual branches is independently measured, and if the shutdown action of the protection devices is independently performed in the individual branches, then the above-described redundant protection can be used for multiple sets of branches and sub-circuits. Also, if the current, voltage, or power in the individual branches is independently measured, and if the shutdown action of the protection devices is independently performed in the individual branches, then a single protection device can monitor multiple branched and sub-circuits. Put another way, a single device can toggle between a plurality of branches and sub-circuits or can toggle between multiple ports.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, auricle, or apparatus that comprises, has, includes, or contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. in addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than ail features of a single disclosed embodiment. Thus, the following claims are hereby incorporated into the Detailed Description, with each claim standing on its own as a separately claimed subject matter.

1. An electrical circuit connected between a power source and a plurality of loads, comprising:
a plurality of load protection devices connected in parallel in a plurality of branches of a multi-branch sub-circuit, each one of the load protection devices being connected to each load in a respective branch; and
a single power protection device connected in series between the power source and the multi-branch sub-circuit,
wherein each one of the load protection devices in a respective branch and the single power protection device enable the electrical circuit to have a Class 2 rating.

2. The electrical circuit of claim 1, wherein the load protection devices independently perform load protection in the branches, and wherein at least one of the load protection devices is shared between the branches.
